(19) United States
(12) Patent Application Publication
(10) Pub. No.: US 2022/0080302 A1
(43) Pub. Date: Mar. 17, 2022

(54) APPARATUS FOR REPRODUCING TEMPERATURE FOR METAVERSE

(71) Applicant: WHOBORN INC., Seoul (KR)

(72) Inventor: Young Sik BAE, Seoul (KR)

(21) Appl. No.: 17/477,295

(22) Filed: Sep. 16, 2021

(30) Foreign Application Priority Data
Sep. 17, 2020 (KR) 10-2020-0119884
Sep. 6, 2021 (KR) 10-2021-0118463

(51) Int. Cl. A63F 13/25; G05D 23/19; G01K 13/20; A63F 13/217

(52) U.S. Cl. CPC A63F 13/25; G05D 23/1917; A63F 2300/8082; A63F 13/217; G01K 13/20

(57) ABSTRACT

Provided is a temperature reproducing apparatus including a content playback unit configured to play back content, a temperature measurement unit configured to measure an ambient temperature using at least one temperature sensor. The ambient temperature may include a body temperature of a user, a processor configured to determine a temperature to be reproduced to the user based on at least one of the content, the ambient temperature, and a temperature set by the user. The temperature reproducing apparatus may include a temperature reproduction unit configured to reproduce the temperature determined by the processor using at least one temperature reproduction approaches.

### RELATED APPLICATION

This application claims benefit of priority to Korean Patent Application number 10-2021-0118463, filed on Sep. 6, 2021, titled TEMPERATURE REPRODUCING APPARATUS FOR METAVERSE and Korean Patent Application number 10-2020-0119884, filed on Sep. 17, 2020, titled WEARABLE TEMPERATURE TRANSFER DEVICE CONSIDERING CONTENT AND AMBIENT TEMPERATURE, which are both incorporated herein by reference in their entirety for all purposes.

### BACKGROUND

The present disclosure relates to a temperature reproducing apparatus.

Extended reality (XR) refers to the combination of all virtual reality created by computer technology and wearable devices and is a concept that includes all of virtual reality (VR), augmented reality (AR), and mixed reality (MR). With the growth of the XR market, the demand for multimodal systems that input and reproduce data about the human senses is increasing. In particular, the multimodal system may be effectively used in various virtual training systems such as medical fields such as surgery, defense fields such as shooting training or pilot training, and education fields such as driving or playing musical instruments and may also be used to implement a metaverse where users may interact with each other, such as providing specific services or buying and selling products.

The multimodal system requires a plurality of XR output devices, such as a display device, a headphone, and a haptic device, in order to transmit human five senses to a user. In order to reproduce the five senses more realistically, contents such as video, audio, and haptics may be synchronized and reproduced in each XR output device.

Meanwhile, when providing content such as audio or video to a user, a method of processing the content itself, such as a 3D audio mix, is used to increase realism and immersion.

Some examples of wearable devices may be found in US published patent application US 2018/0095534 A1 published Apr. 5, 2018.

### SUMMARY

The present disclosure may provide content so that users may feel realism and immersion, and to provide a temperature reproducing apparatus for minimizing power consumption during heating and cooling.

However, approaches disclosed herein by the present disclosure is not limited thereto and may be variously expanded without departing from the spirit and scope of the present claimed subject matter.

According to an embodiment, a temperature reproducing apparatus may include: a content playback unit configured to play back content; a temperature measurement unit configured to measure an ambient temperature using at least one temperature sensor, wherein the ambient temperature may include a body temperature of a user; a processor configured to determine a temperature to be reproduced to the user based on at least one of the content, the ambient temperature, and a temperature set by the user; and a temperature reproduction unit configured to reproduce the temperature determined by the processor using at least one temperature reproduction means.

According to one example, the processor may determine a first temperature to be reproduced to the user based on the content and determine a second temperature to be reproduced to the user by correcting the first temperature to be reproduced to the user based on the ambient temperature.

According to one example, the processor may generate a first temperature map representing the first temperature, generate a second temperature map indicating a first ambient temperature measured by the temperature measurement unit and a second ambient temperature estimated based on the first ambient temperature, generate a third temperature map representing a correction value of the first temperature based on the first ambient temperature and the second ambient temperature, and generate a fourth temperature map representing the second temperature based on the first temperature map and the third temperature map.

According to one example, the temperature measurement unit may measure the ambient temperature in a three-dimensional form.

According to one example, the temperature sensor may be a non-contact type temperature sensor that measures the ambient temperature in a state that does not come into contact with the user.

According to one example, the temperature reproduction means may include a first temperature reproduction means for heating the user by an exothermic reaction and a second temperature reproduction means for cooling the user by an endothermic reaction.

According to one example, the at least one temperature sensor and the at least one temperature reproduction means may be distributed by a predetermined distance from each other and arranged in a grid pattern.

According to one example, the at least one temperature sensor and the at least one temperature reproduction means may be arranged to constitute a plurality of layers and are arranged in different layers.

According to one example, when the content is audio, the processor may determine the temperature to be reproduced to the user based on at least one of a frequency, a pattern, a tempo, and a beat of the audio.

According to one example, when the content is a virtual reality (VR) simulation, the processor may determine the temperature to be reproduced to the user based on a relative position of an object included in the VR simulation and the user within the VR simulation.

### BRIEF DESCRIPTION OF THE DRAWINGS

Embodiments can be understood in more detail from the following description taken in conjunction with the accompanying drawings, in which:

FIG. 1 is a block diagram showing the configuration of a temperature reproducing apparatus according to an embodiment;

FIGS. 2A and 2B show various arrangement examples of a temperature sensor and a thermoelectric element in a temperature reproducing apparatus according to an embodiment;

FIG. 3 is a flowchart of a method for determining a relative temperature to be transmitted to a user by a temperature reproducing apparatus according to an embodiment;

FIG. 4 is a data flow diagram of a temperature reproducing apparatus according to an embodiment;

FIG. 5 shows an example in which the temperature reproducing apparatus according to an embodiment is implemented as a headphone;

FIG. 6 is a diagram illustrating a data processing flow in the headphone of FIG. 5;

FIG. 7 illustrates an example in which a temperature reproducing apparatus according to an embodiment is implemented as an HMD;

FIGS. 8A to 8D illustrate a method of generating a second temperature map in the HMD of FIG. 7;

FIG. 9 shows an example in which the temperature reproducing apparatus according to an embodiment is implemented as a garment; and

FIGS. 10A to 10D explain a method of generating the first to fourth temperature maps in the garment of FIG. 9.

### DETAILED DESCRIPTION OF EMBODIMENTS

Since the present disclosure may apply various modifications and have various embodiments, specific embodiments are illustrated with reference to the drawings and will be described in detail.

However, this is not intended to limit the present disclosure to specific embodiments, and should be understood to include all modifications, equivalents and substitutes included in the spirit and scope of the present disclosure.

It will be understood that the terms “first” and “second” are used herein to describe various components but these components should not be limited by these terms. The above terms are used only to distinguish one component from another. For example, a first component may be referred to as a second component and vice versa without departing from the scope of the inventive concept.

When a component is referred to as being “connected” or “coupled” to another component, it may be directly connected or coupled to the other element, but it should be understood that another component may exist in the middle. On the other hand, when it is mentioned that a certain element is “directly connected” or “directly coupled” to another element, it should be understood that the other element does not exist in the middle.

The terms used in the present application are used only to describe specific embodiments and are not intended to limit the present disclosure. The terms of a singular form may include plural forms unless otherwise specified. In this specification, the term “include” or “comprise” specifies a property, a region, a fixed number, a step, a process, an element and/or a component but does not exclude other properties, regions, fixed numbers, steps, processes, elements and/or components.

Unless defined otherwise, all terms used herein, including technical and scientific terms, have the same meaning as commonly understood by one of ordinary skill in the art to which this disclosure belongs. Terms such as those defined in a commonly used dictionary should be interpreted as having a meaning consistent with the meaning in the context of the related art and are not interpreted in an ideal or excessively formal meaning unless explicitly defined in the present application.

Hereinafter, with reference to the accompanying drawings, embodiments will be described clearly and in detail so that a person of ordinary skill in the art to which the disclosure pertains may easily practice the disclosure.

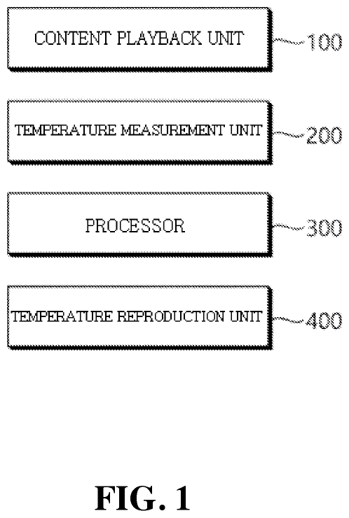

FIG. 1 is a block diagram showing the configuration of a temperature reproducing apparatus according to an embodiment. For example, a temperature reproducing apparatus may be implemented as a device in direct contact with a user such as a headphone, a head mounted display (HMD), a face mounted display (FMD), a helmet mounted display, a hat, gloves, shoes, or garments, or may also be implemented as a non-contact device that uses non-contact means (e.g., wind) to reproduce the temperature. In addition, the temperature reproducing apparatus according to an embodiment may synchronize the operation of each component using a multimodal interface.

Referring to FIG. 1, a temperature reproducing apparatus according to an embodiment includes a content playback unit 100, a temperature measurement unit 200, a processor 300, and a temperature reproduction unit 400.

The content playback unit 100 reproduces content. For example, the content playback unit 100 may be a speaker that reproduces audio content or a display that displays video content such as a virtual reality (VR) simulation.

Here, the content may include all of the built-in content produced in advance and stored in the temperature reproducing apparatus, the external content transmitted from the outside, and the generated content generated in the temperature reproducing apparatus. In addition, the content may be temporarily or non-temporarily stored in storage devices such as RAM or FLASH, and the external content includes data transmitted by various wireless communication methods such as cellular (e.g., 4G, 5G, etc.), WiFi, and Bluetooth. That is, the content may include not only the audio and video exemplified above, but also any other form of content.

The temperature measurement unit 200 measures the ambient temperature using at least one temperature sensor. Here, “ambient” means the ambient of the temperature transmission device itself, and thus “ambient temperature” includes the user's body temperature as well as the air temperature or room temperature. As the number of temperature sensors is more, more precise measurement is possible.

The temperature measurement unit 200 may measure ambient temperature not only in a two-dimensional form but also in a three-dimensional form. For example, when measuring the temperature of the user's face, if it is measured in a three-dimensional form, the temperature that changes according to the height difference such as the forehead, nose, and cheek may be measured.

The temperature sensor may be configured as a contact-type temperature sensor that is attached to the user's body and measures the temperature of the attached point and may be configured as a non-contact type temperature sensor that measures the temperature in a state that is not in contact with the user, such as a thermal imaging camera.

The processor 300 determines a temperature to be reproduced to the user based on at least one of content, ambient temperature, and a temperature set by the user.

The temperature based on the content may be determined according to the detailed content of the content.

When the content is audio (e.g., music), the processor 300 may determine the temperature to be reproduced according to the pitch (i.e., frequency), pattern, tempo, beat, etc. of the sound. The processor 300 may determine to reproduce a relatively high temperature in a treble sound and may determine to reproduce a relatively low temperature in a low sound. In addition, the processor 300 may determine to reproduce a relatively high temperature at a fast tempo and determine to reproduce a relatively low temperature at a slow tempo.

In addition, the processor 300 may provide a temperature maintenance function according to a change in the user's body temperature. When listening to audio, the user's body temperature may change depending on the pitch, tempo, beat, etc. For example, when listening to music or sound with a strong beat, the user's body temperature rises, and the user may feel uncomfortable because it becomes relatively hot. At this time, the processor 300 determines the temperature to be reproduced for the user according to the body temperature of the user measured by the temperature measurement unit 200 so that it may allow the user to comfortably listen to the audio.

When the content is a video (e.g., VR simulation), the processor 300 may determine a temperature to be reproduced according to the VR object. If there is a hot object near the user within the VR simulation, the processor 300 may determine to reproduce a relatively high temperature in a direction in which a hot object is present and a relatively low temperature in the opposite direction. The temperature transmission device may additionally include a sensor (e.g., a 9-axis sensor) capable of measuring the user's rotation, and when the user rotates to change the relative position of the hot object and the user within the VR simulation, the processor 300 may determine the temperature to be reproduced based on the changed relative position.

Meanwhile, the determination of the temperature based on the content may be performed not only by the processor 300 analyzing the content, but also by the creator or user of the content, as in the above-described example. For example, an audio content producer may insert temperature information for each playback time into the audio content by determining in advance what temperature a user will experience for each audio playback time according to their creative intention. In this case, the processor 300 may determine the temperature to be reproduced by extracting temperature information for each playback time. Also, for example, like the audio equalizer setting, the user may set the temperature to be reproduced according to the pitch, pattern, tempo, beat, playback time, etc. of the sound, and the processor 300 may determine a temperature to be reproduced according to a user's setting.

The temperature based on the ambient temperature may be a correction of the temperature based on the content or may be determined according to the external temperature (e.g., air temperature or room temperature).

The processor 300 may reproduce the relative temperature to the user by correcting the reproduction temperature determined based on the content based on the ambient temperature. For example, even if deciding to reproduce a temperature of 38° C. based on the content, if the user's body temperature is 35° C., the processor 300 may correct the temperature based on the content by reproducing the temperature of 37° C., and if the user's body temperature is 37° C., may correct the temperature based on the content by reproducing a temperature of 39° C. Conversely, even deciding to reproduce a temperature of 34° C. based on the content, if the user's body temperature is 35° C., the processor 300 may correct the temperature based on the content by reproducing the temperature of 33° C., and if the user's body temperature is 37° C., may correct the temperature based on the content by reproducing a temperature of 35° C.

The processor 300 may generate a temperature map based on the ambient temperature measured by the temperature measurement unit 200 to correct the reproduction temperature based on the ambient temperature. The temperature map may be configured in the form of a matrix.

Specifically, the processor 300 may generate a first temperature map indicating a temperature to be reproduced to the user determined based on the content. The first temperature map is composed of cells (or components) corresponding to a point at which a temperature is to be reproduced, and a temperature based on content to be reproduced at the corresponding point may be recorded in each cell. The temperature determined based on the content may be determined, for example, assuming that the user's body temperature is 36° C.

The processor 300 may generate a second temperature map indicating the second ambient temperature estimated based on the first ambient temperature measured by the temperature measurement unit 200 and the ambient temperature measured by the temperature measurement unit 200. Here, the second ambient temperature means that the temperature of the point where the temperature measurement unit 200 cannot directly measure the temperature is estimated based on the first ambient temperature.

The processor 300 may generate a third temperature map indicating a correction value of a temperature to be reproduced to the user determined based on the content based on the first ambient temperature and the second ambient temperature. For example, when the temperature determined based on the content is determined by assuming that the user's body temperature is 36° C., the correction value may be determined as a temperature capable of reproducing the same feeling (i.e., a temperature difference) to the user based on the measured and estimated temperature recorded in the second temperature map.

The processor 300 may generate a fourth temperature map indicating a temperature to be transmitted to the user determined (i.e., corrected) based on the ambient temperature based on the first temperature map and the third temperature map.

Estimation of the ambient temperature through the temperature map and correction of the reproduced temperature will be described later through specific examples with reference to other drawings.

Meanwhile, the processor 300 may determine a temperature to be reproduced to the user according to an external temperature (e.g., air temperature or room temperature). As described above, the temperature measurement unit 200 may measure not only the user's body temperature but also the external temperature. The processor 300 may determine a temperature to be reproduced to the user so as to deliver a specific temperature according to the measured external temperature. When the outside temperature is low, such as in winter, the processor 300 may determine a temperature to be reproduced for the user as a relatively high temperature and provide a heating function to the user. Conversely, when the external temperature is high, such as in summer, the processor 300 may provide a cooling function to the user by determining the temperature to be reproduced to the user as a relatively low temperature.

The temperature reproduction unit 400 reproduces the temperature determined by the processor using at least one temperature reproduction means. For example, the temperature reproduction means may include a thermoelectric element that may heat the user by an exothermic reaction and cool the user by an endothermic reaction and may include a hot thermoelectric element that may only heat the user and a cold thermoelectric element that may only cool the user. Temperature reproduction means may include an element having a thermoelectric effect, such as the Seebeck effect, the Peltier effect, and the Thompson effect, and also any element using similar technology in other ways capable of generating a temperature determined by a user or a processor. As another example, the temperature reproduction means may use water (hot/cold water) or may use wind (hot/cold air). On the other hand, when there are a plurality of temperature reproduction means, the temperature reproduction unit 400 may reproduce different temperatures for each target position of each temperature reproduction means.

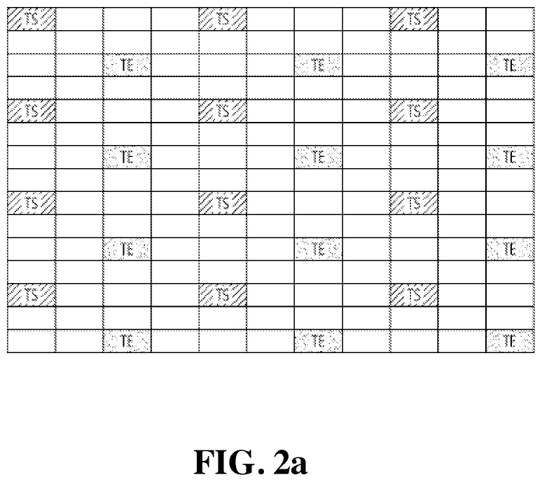

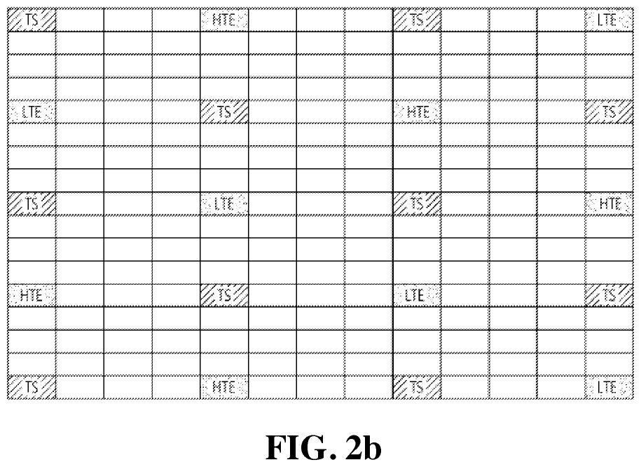

FIGS. 2A and 2B show examples of various arrangements of a temperature sensor and a temperature reproduction means in a temperature reproducing apparatus according to an embodiment.

The temperature sensor and the temperature reproduction means may be arranged according to the convenience of implementation without special rules, but as shown in FIG. 2A, may be arranged in a grid pattern while being distributed by a predetermined distance from each other. That is, by arranging a temperature sensor (indicated by TS in FIG. 2A) at a certain point, it is possible to directly measure the temperature at that point and estimate the temperature at the remaining points, and by placing the temperature reproduction means (indicated by TE in FIG. 2A) at another point that does not overlap the temperature sensor, the temperature may be transmitted successfully. At this time, it is important to distribute them by a predetermined distance so that the temperature sensor and the temperature reproduction means do not affect each other.

On the other hand, even when the temperature reproduction means is composed of individual hot and cold thermoelectric elements, as shown in FIG. 2B, it may be distributed by a predetermined distance from each other and arranged in a grid pattern.

In addition, the temperature sensor and the temperature reproduction means are arranged to constitute one layer to measure the temperature of the position corresponding to the temperature sensor, respectively, and although it is possible to reproduce the temperature at a position corresponding to each temperature reproduction means, a plurality of layers may be constituted, but the temperature sensor and the temperature reproduction means may be disposed on different layers. Even in this case, the temperature sensor and the temperature reproduction means may be distributed by a predetermined distance from each other as shown in FIGS. 2A and 2B and arranged in a grid pattern, and when it is composed of a plurality of layers, it is possible to increase efficiency in terms of control, interference, and the like.

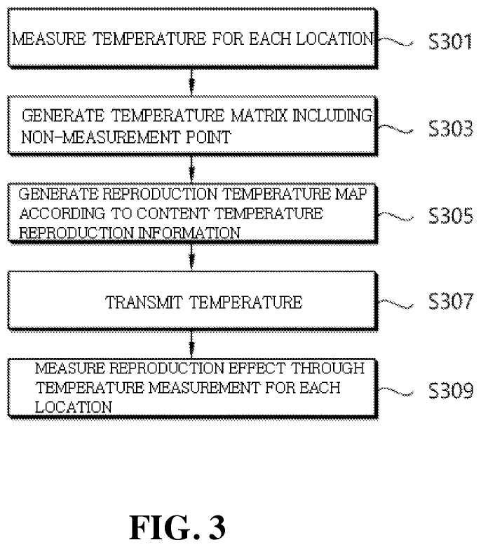

FIG. 3 is a flowchart of a method for determining a relative temperature to be transmitted to a user by a temperature reproducing apparatus according to an embodiment.

Referring to FIG. 3, in step S301, the temperature sensor measures the temperature of each user's location. At this time, there may be more than one temperature sensor, and the more the number, the more precise measurement is possible. As described above, the temperature sensor may be a non-contact type sensor such as a thermal imaging camera as well as a contact type sensor attached to the user's body.

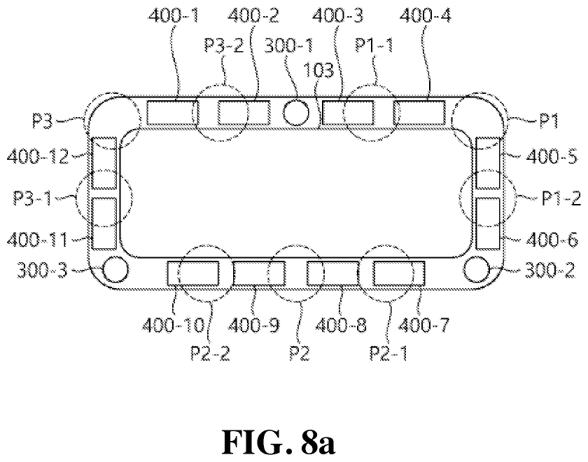

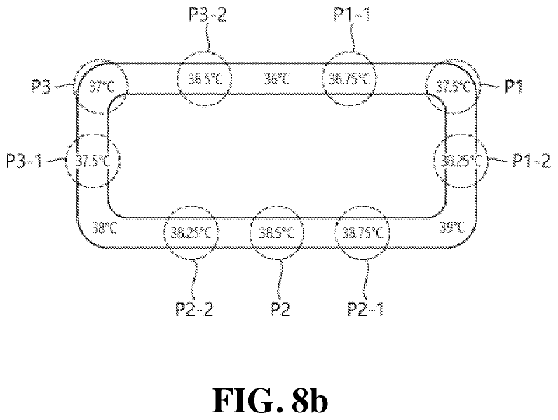

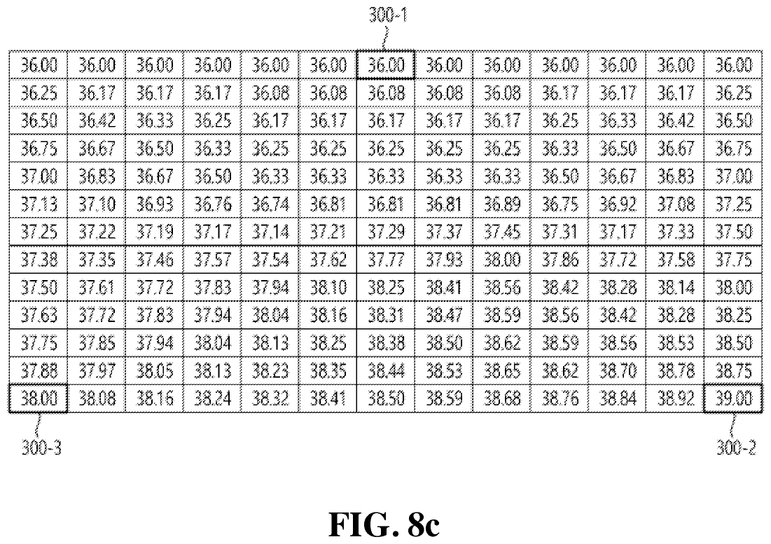

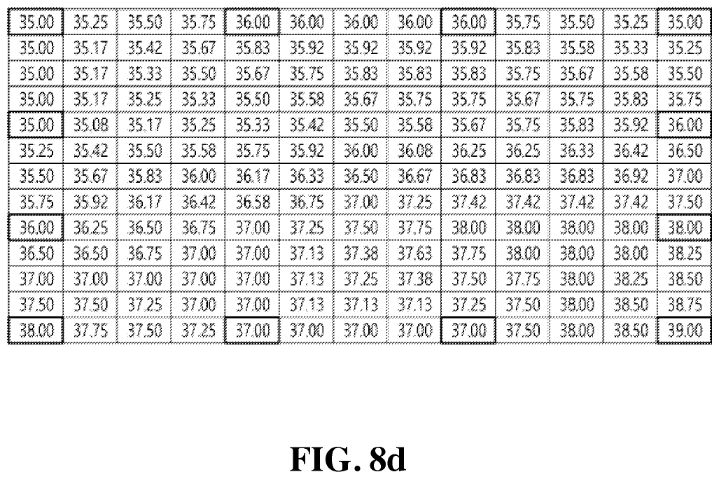

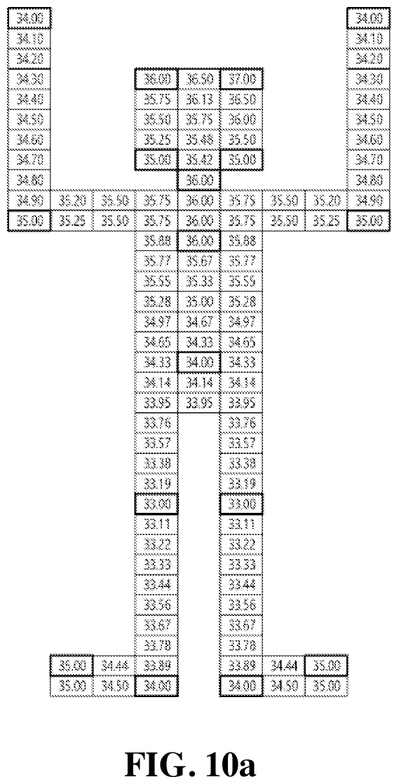

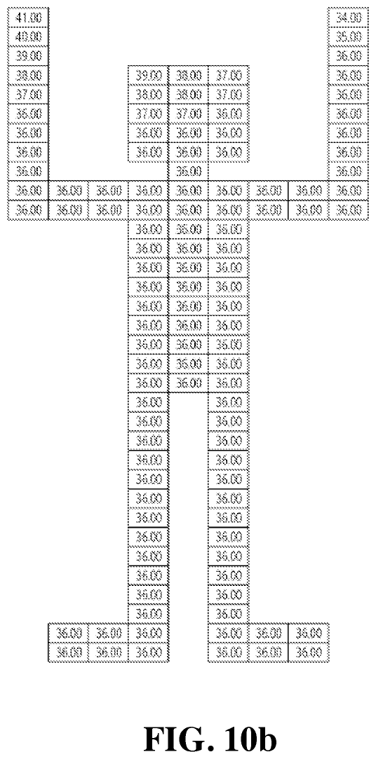

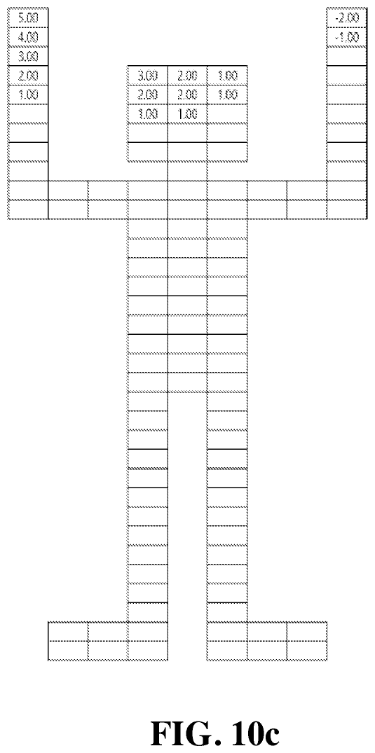

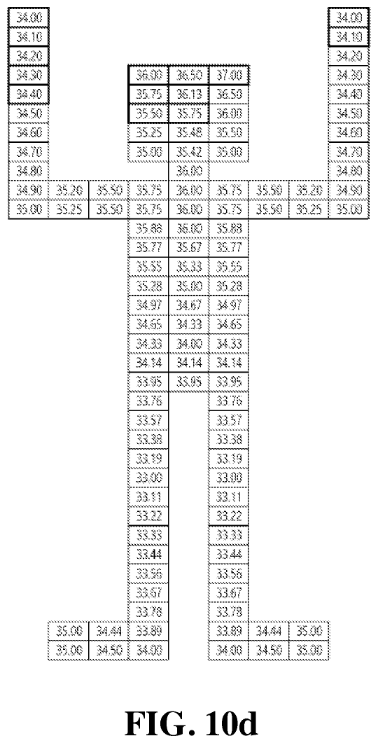

In step S303, the processor 300 generates a temperature matrix including the non-measurement point. As shown in FIGS. 8C, 8D, and 10A, the processor 300 may estimate the temperature of the non-measurement point by using the temperature of the measurement point. Estimation of temperature may be performed by generating a temperature map as described above. In this case, the estimation may be performed using two or more measured values or pre-estimated values and may be performed in various ways such as an average, a median, and a weighted average. Meanwhile, 3D temperature estimation is possible not only when the measurement position is 2D, but also when the measurement position is 3D.

In step S305, the processor 300 generates a reproduction temperature map according to the content temperature reproduction information. That is, the processor 300 generates a final temperature map to be reproduced to the user by using the temperature determined according to the content and the temperature measured and estimated in step S303. At this time, a temperature map according to the absolute temperature (i.e., the temperature based on the content) may be generated as illustrated in FIG. 10B, and a temperature map according to a relative temperature (i.e., a temperature corrected in consideration of temperature measurements and estimation values) may be generated as illustrated in FIG. 10D.

In step S307, the temperature reproduction means reproduces the temperature to the user according to the temperature map generated by the processor 300. As described above, the temperature reproduction means may reproduce the temperature in various ways, such as a cold thermoelectric element, a hot thermoelectric element, a device using water, a device using wind, and the like.

In step S309, the effect of temperature reproduction is measured by measuring the temperature for each location of the user. Step S309 is to check whether the temperature reproduced by the temperature reproduction means is actually well transmitted to the user, and to reflect the relative temperature reproduction later by using the corresponding information. At this time, the temperature measurement may not transmit the temperature at the moment of measurement so as to minimize the effect of the temperature reproduced by the temperature reproduction means, or the temperature of the temperature reproduction means may be measured separately. Step S309 may be selectively applied according to an embodiment.

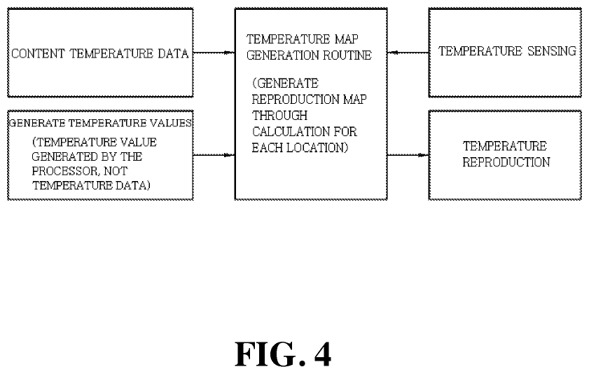

FIG. 4 is a data flow diagram of a temperature reproducing apparatus according to an embodiment.

Referring to FIG. 4, the temperature reproducing apparatus according to an embodiment generates a reproducible temperature map through calculation (estimation) for each location by a temperature map generation routine using content temperature data, temperature measurement values, and temperature values generated through a processor, and reproduces the temperature according to the result. The content temperature data may be, for example, temperature data corresponding to a hot or cold object in a VR simulation, a fast beat portion of audio content, or the like. The temperature measurement value may be the ambient temperature of the temperature reproducing apparatus measured by the temperature sensor. The temperature map generation routine may be a process to be described later with reference to FIGS. 8C, 8D, and 10A to 10D.

Hereinafter, as a specific implementation example of the temperature reproducing apparatus according to an embodiment, operation when implemented with headphones, HMD, and clothes will be described. In this specification, although it is explained with examples implemented with headphones, HMDs, and clothes, the implementation manner of the present disclosure is not limited thereto.

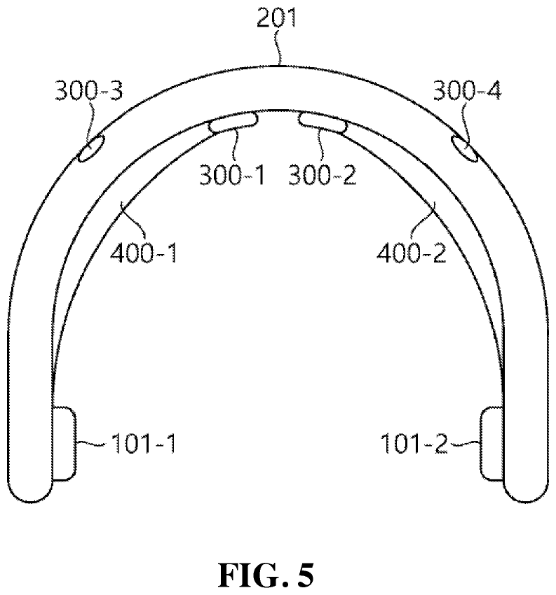

FIG. 5 shows an example in which the temperature reproducing apparatus according to an embodiment implemented as a headphone.

Referring to FIG. 5, the headphones may include speakers 101-1 and 101-2, a headband 201, temperature sensors 300-1 to 300-4, and temperature reproduction means 400-1 and 400-2. Although not explicitly shown in FIG. 5, the headphone may include a processor, and the processor may be located inside the headband 201.

The speakers 101-1 and 101-2 play back audio content such as music. Although two speakers 101-1 and 101-2 are shown in FIG. 5, the present disclosure is not limited thereto, and may include a larger number of speakers to implement multiple channels, for example, 5.1-channel or 7.1-channel.

The headband 201 may be configured to cover the user's head so that the user may wear headphones. The headband 201 may be coupled to speakers 101-1 and 101-2, temperature sensors 300-1 to 300-4, and temperature reproduction means 400-1 and 400-2. As shown in FIG. 5, the speakers 101-1 and 101-2, the temperature sensors 300-1 and 300-2, and the temperature reproduction means 400-1 and 400-2 may be coupled to the inner surface of the headband 201, and the temperature sensors 300-3 and 300-4 may also be coupled to the outer surface of the headband 201.

The temperature sensors 300-1 to 300-4 measure the temperature of the position to which they are attached. Although four temperature sensors 300-1 to 300-4 are illustrated in FIG. 5, the present disclosure is not limited thereto, and a larger number or a smaller number of temperature sensors may be included. The temperature sensors 300-1 and 300-2 attached to the inner surface of the headband 201 may contact the user's skin when the user wears the headphones to measure the user's body temperature. The temperature sensors 300-3 and 300-4 attached to the outer surface of the headband 201 may measure an external temperature (e.g., air temperature or room temperature) when the user wears headphones.

The temperature reproduction means 400-1 and 400-2 reproduce the temperature determined by the processor. In FIG. 5, two temperature reproduction means 400-1 and 400-2 in a form that may be in contact with the user's head in contact with the inner surface of the headband 201 are shown, but the present disclosure is not limited thereto, and a larger number of temperature reproduction means may be included to subdivide the temperature transmission point.

On the other hand, headphones may be used alone to playback audio content, but may also be used in conjunction with other devices including displays to playback video and audio combined content.

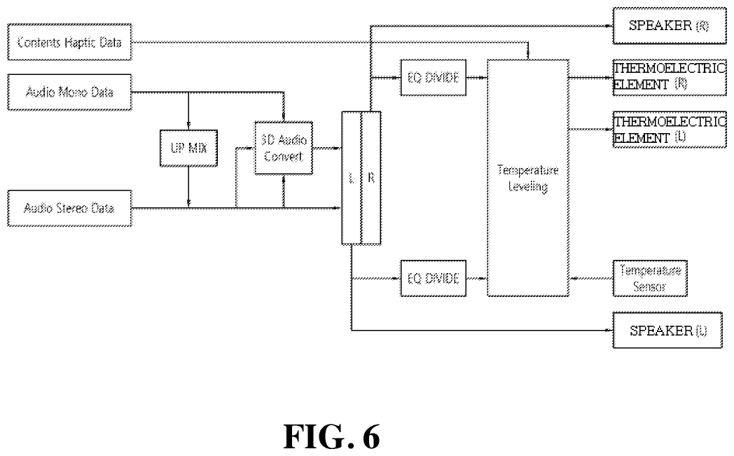

FIG. 6 is a diagram illustrating a data processing flow in the headphone of FIG. 5. The data processing shown in FIG. 6 may be performed by the processor 300.

The audio data may include at least one of audio mono data and audio stereo data, and when there is only audio mono data, it may be converted into audio stereo data using UP MIX. Audio mono data and audio stereo data may be separated into a left output and a right output after undergoing 3D audio conversion. The separated left and right outputs may be played back through each speaker.

Meanwhile, temperature leveling may be performed based on content haptic data, audio data, and measured temperature. At this time, the audio data separated into the left and right outputs may be separated for each frequency by an equalizer and used for temperature leveling. As described above, the temperature leveling may be to determine the temperature to be delivered to the user based on factors determined by the content creator (i.e., content haptic data and audio data in the example of FIG. 4) and the temperature measured by the temperature sensor.

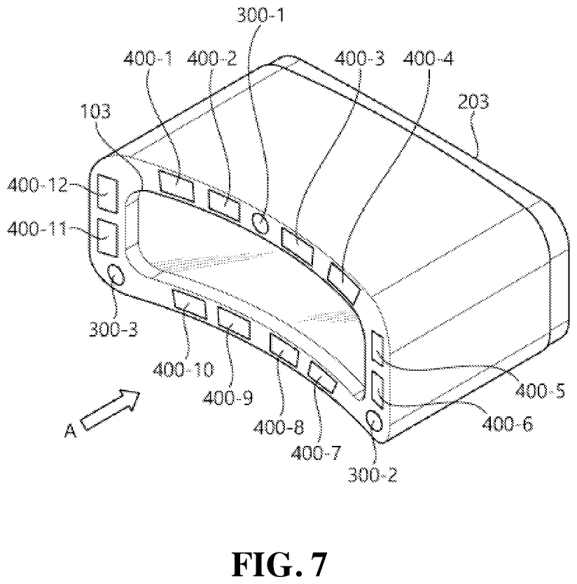

FIG. 7 illustrates an example in which a temperature reproducing apparatus according to an embodiment implemented as an HMD.

Referring to FIG. 7, the HMD may include a display 103, a body 203, temperature sensors 301-1 to 301-3, and temperature reproduction means 400-1 to 400-12. Although not explicitly shown in FIG. 7, the HMD may include a processor, and the processor may be located inside the body 203.

The display 103 plays back video content (e.g., VR simulation).

The display 103, the temperature sensors 300-1 to 300-3, and the temperature reproduction means 400-1 to 400-12 may be coupled to the body 203. As shown in FIG. 7, the temperature sensors 300-1 to 300-3 and the temperature reproduction means 400-1 to 400-12 may be coupled to the inner surface of the body 203.

The temperature sensors 300-1 to 300-3 measure the temperature of the position to which they are attached. Although three temperature sensors 300-1 to 300-3 are illustrated in FIG. 7, the present disclosure is not limited thereto, and a larger number or a smaller number of temperature sensors may be included. In addition, although not explicitly shown in FIG. 7, a temperature sensor is also attached to the outer surface of the body to measure the external temperature.

When the user wears the HMD, the temperature sensors 300-1 to 300-3 may contact the user's skin to measure the user's body temperature. The temperature of the point where the temperature sensors 300-1 to 300-3 are not attached may be estimated using the temperature of the point where the temperature sensors 300-1 to 300-3 are attached. The estimation of the temperature will be described later with reference to FIGS. 8A to 8D.

The temperature reproduction means 400-1 to 400-12 reproduce the temperature determined by the processor. In FIG. 7, as another example from the headphone of FIG. 5, it is shown that 12 temperature reproduction means 400-1 to 400-12 are attached to the inner surface of the body 203, but the present disclosure is not limited thereto.

On the other hand, the HMD may be used alone to playback video content but may also be used with other devices including speakers to play back video and audio combined content.

FIGS. 8A to 8D illustrate a method of generating a second temperature map in the HMD of FIG. 7.

FIGS. 8A and 8B are plan views of the HMD of FIG. 7 as viewed from the direction A.

Referring to FIG. 8A, as shown in FIG. 7, three temperature sensors 300-1 to 300-3 and 12 temperature reproduction means 400-1 to 400-12 are attached to the inner surface of the HMD. The temperature sensors 300-1 to 300-3 each measure the temperature of the point to which they are attached, and the temperature reproduction means 400-1 to 400-12 transmit the temperature determined by the processor to the user. At this time, the processor may determine the temperature to be reproduced by the temperature reproduction means 400-1 to 400-12 attached to the point where the temperature sensors 300-1 to 300-3 are not attached based on the temperature measured by the temperature sensors 300-1 to 300-3.

For this, the processor may estimate the temperatures of points P1, P1-1, P1-2, P2, P2-1, P2-2, P3, P3-1, and P3-3 to which the temperature sensors 300-1 to 300-3 are not attached based on the temperature measured by the temperature sensors 300-1 to 300-3. For example, the processor may estimate the temperatures of points P1, P1-1, P1-2, P2, P2-1, P2-2, P3, P3-1, and P3-3 to which the temperature sensors 300-1 to 300-3 are not attached using the average of the temperatures measured by the temperature sensors 300-1 to 300-3.

Referring to FIG. 8B, for example, when the temperature measured by the temperature sensor 300-1 is 36° C., the temperature measured by the temperature sensor 300-2 is 39° C., and the temperature measured by the temperature sensor 300-3 is 35° C., the processor may estimate the temperature of the points P1, P2, and P3 as an average of temperatures measured by the respective temperature sensors 300-1 to 300-3. That is, the processor may estimate the temperature of the point P1 as 37.5° C., the temperature of the point P2 as 38.5° C., and the temperature of the point P3 as 37° C. In addition, the processor may estimate the temperatures of the points P1-1, P1-2, P2-1, P2-2, P3-1, and P3-2 as an average of the temperature estimated at the points P1, P2, and P3 and the temperature measured by the temperature sensors 300-1 to 300-3. That is, the processor may estimate the temperature of the point P1-1 as 36.75° C., the temperature of point P1-2 as 38.25° C., the temperature of point P2-1 as 38.75° C., the temperature of point P2-2 as 38.25° C., the temperature of the point P3-1 as 37.5° C., and the temperature of the point P3-2 as 36.5° C.

In the example of FIGS. 8A and 8B, the processor estimates the temperature of the point where the temperature sensors 300-1 to 300-3 are not attached using the average, but the present disclosure is not limited thereto, and it will be appreciated that a person skilled in the art may estimate the temperature using other representative values such as a median and a mode in addition to the mean, and may estimate the temperature using a weighted average with different weights depending on the location where the temperature sensor is attached or the distance between each temperature sensor.

As described above, the processor may estimate the temperature by generating a temperature map. As shown in FIG. 8C, a temperature map is generated based on the temperature measured by the temperature sensors 300-1, 300-2, and 300-3, indicated by thick lines to estimate the temperature of the user's entire face. At this time, for example, by estimating the temperature corresponding to a specific component (e.g., the middle component of the temperature map, the outermost intermediate component of the temperature map, etc.) based on the temperature measured by the temperature sensors 300-1, 300-2, and 300-3 and estimating the temperature corresponding to the other component based on the measured temperature and the temperature estimate of the specific component, the temperature corresponding to each component of the temperature map may be estimated by repeating the estimations.

Also, as shown in FIG. 8D, when the number of temperature sensors is increased, the temperature distribution of a part to be measured may be more precisely measured and estimated.

In the case of estimating the temperature by generating a temperature map as shown in FIGS. 8C and 8D, since the temperature distribution of the user's face may be estimated, the processor may determine a reproduction temperature that is more suitable for the current temperature distribution compared to the example of FIGS. 8A and 8B.

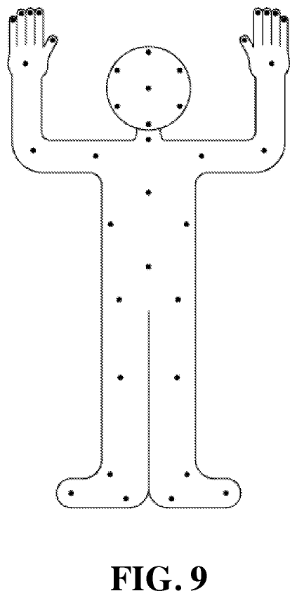

FIG. 9 shows an example in which the temperature reproducing apparatus according to an embodiment implemented as a garment. The garment may be used with the headphones or HMD described above.

Referring to FIG. 9, a temperature sensor may be attached to a part of the garment corresponding to the specific part to measure the temperature of a specific part (e.g., each joint part) of the user's body. At this time, the temperature sensor may be attached to the rear as well as the front of the user.

The temperature of the location to which the temperature sensor is not attached may be estimated by the processor. In the case of the face, it may be estimated by predicting the 3D matrix distribution of the temperature based on the temperature measured at the point where the temperature sensor is attached. This will be described later with reference to FIGS. 10A to 10D.

On the other hand, the garment may be implemented so that both temperature measurement and temperature reproduction may be performed using dual materials capable of sensing the temperature of the entire area and haptic output.

FIGS. 10A to 10D explain a method of generating the first to fourth temperature maps in the garment of FIG. 9.

FIG. 10A shows a first temperature map. Referring to FIG. 10A, when temperature sensors are disposed at points indicated by thick lines in the first temperature map (that is, four on the head, one on the neck, one on each hand, one on each elbow, one on chest, one on abdomen, one on each knee, two on each foot), the temperature of the portion where the temperature cannot be directly measured may be estimated by the same method as the method described above with reference to FIGS. 8A to 8D.

FIG. 10B shows a second temperature map. For example, if the content is a VR simulation, there is a hot object or environment in the upper left corner of the user, and there is a cold object or environment in the upper right corner of the user, the processor may determine the reproduction temperature based on the content, such as a numerical value shown in FIG. 10B. In this case, the processor may determine a reproduction temperature based on the content based on a specific temperature (e.g., 36° C.). Therefore, in FIG. 10b, it was decided to transmit 41° C. at the left hand end and 34° C. at the right hand end.

FIG. 10C shows a third temperature map. That is, since the processor in FIG. 10B determined the reproduction temperature based on the content based on 36° C., it is enough to reproduce the relative temperature as much as the temperature shown in FIG. 10C to the user. As a result, the processor 300 may determine the reproduction temperature based on the ambient temperature as in the fourth temperature map of FIG. 10D by adding the correction value recorded in the third temperature map of FIG. 10C to the user's body temperature recorded in the first temperature map of FIG. 8A, and the temperature reproduction means may deliver the corresponding temperature to the user. As explained above, when the relative temperature is reproduced by correcting the reproduction temperature based on the content based on the ambient temperature, depending on the user's body temperature, the user may recognize the high temperature even if a relatively lower temperature is actually reproduced, and it has the advantage of adding an efficient temperature change, and the user may feel the temperature change with certainty. In addition, even if a relatively low temperature is reproduced in some cases, the user may recognize a high temperature, so that power consumption may be reduced. On the other hand, the relative temperature may be individually set for each user, so that it is possible to provide customized temperature reproduction to the elderly or the physically and mentally weak. Additionally, it may be used for treatment in the medical field as well as for content playback.

The disclosed technology may have the following effects. However, this does not mean that a specific embodiment should include all of the following effects or only the following effects, so the scope of the disclosed technology should not be construed as being limited thereby.

According to the temperature reproducing apparatus according to the above-described embodiments, it is possible to provide content so that a user may feel realism and immersion, and to minimize power consumption during heating and cooling.

Although described above with reference to the drawings and embodiments, it does not mean that the protection scope of the present disclosure is limited by the drawings or embodiments, and it will be understood by those skilled in the art that various modifications and changes may be made in the present disclosure without departing from the spirit and scope of the present disclosure as set forth in the following claims.

What is claimed is:

1. A temperature reproducing apparatus comprising:
a content playback unit configured to play back content;
a temperature measurement unit configured to measure an ambient temperature using at least one temperature sensor, wherein the ambient temperature includes a body temperature of a user;
a processor configured to determine a temperature to be reproduced to the user based on at least one of the content, the ambient temperature, and a temperature set by the user; and
a temperature reproduction unit configured to reproduce the temperature determined by the processor using at least one temperature reproduction means.

2. The temperature reproducing apparatus of claim 1, wherein the processor determines a first temperature to be reproduced to the user based on the content, and
determines a second temperature to be reproduced to the user by correcting the first temperature to be reproduced to the user based on the ambient temperature.

3. The temperature reproducing apparatus of claim 2, wherein the processor generates a first temperature map representing the first temperature,
generates a second temperature map indicating a first ambient temperature measured by the temperature measurement unit and a second ambient temperature estimated based on the first ambient temperature,
generates a third temperature map representing a correction value of the first temperature based on the first ambient temperature and the second ambient temperature, and
generates a fourth temperature map representing the second temperature based on the first temperature map and the third temperature map.

4. The temperature reproducing apparatus of claim 1, wherein the temperature measurement unit measures the ambient temperature in a three-dimensional form.

5. The temperature reproducing apparatus of claim 1, wherein the temperature sensor is a non-contact type temperature sensor that measures the ambient temperature in a state that does not come into contact with the user.

6. The temperature reproducing apparatus of claim 1, wherein the temperature reproduction means comprises a first temperature reproduction means for heating the user by an exothermic reaction and a second temperature reproduction means for cooling the user by an endothermic reaction.

7. The temperature reproducing apparatus of claim 1, wherein the at least one temperature sensor and the at least one temperature reproduction means are distributed by a predetermined distance from each other and arranged in a grid pattern.

8. The temperature reproducing apparatus of claim 7, wherein the at least one temperature sensor and the at least one temperature reproduction means are arranged to constitute a plurality of layers and are arranged in different layers.

9. The temperature reproducing apparatus of claim 1, wherein when the content is audio, the processor determines the temperature to be reproduced to the user based on at least one of a frequency, a pattern, a tempo, and a beat of the audio.

10. The temperature reproducing apparatus of claim 1, wherein when the content is a virtual reality (VR) simulation, the processor determines the temperature to be reproduced to the user based on a relative position of an object included in the VR simulation and the user within the VR simulation.
